(19) United States
(12) Patent Application Publication
(10) Pub. No.: US 2016/0370886 A1
(43) Pub. Date: Dec. 22, 2016

(54) OPTICAL POSITIONING APPARATUS AND METHOD

(71) Applicants: Jabin Jang, Fairfax, VA (US); Hsin-Hang Tsou, Tainan City (TW)

(72) Inventors: Jabin Jang, Fairfax, VA (US); Hsin-Hang Tsou, Tainan City (TW)

(21) Appl. No.: 14/742,677

(22) Filed: Jun. 17, 2015

(51) Int. Cl. G06F 3/0354; G06F 3/03; G06F 3/038

(52) U.S. Cl. CPC G06F 3/03542; G06F 3/0386; G06F 3/03545; G06F 3/0325; G06F 2203/0384

(57) ABSTRACT

An apparatus and method to identify the location of stylus including at least one processing unit, a light-emitting stylus, two scanning receivers attached on the screen surface of the display device including computer, notebook, tablet, television, whiteboard, touch display or non-touch display. The scanning receivers include photosensors with pass filters to capture the specific wavelength of light emitting from the pen tip of the stylus. The process unit is able to calculate the location through triangulation based on the preset distance of the two scanning receivers, and the varying angles between the two scanning receivers and the pen tip of the stylus.

### CROSS-REFERENCE TO RELATED APPLICATIONS

Not Applicable

### The Substitute Specification Contains No New Matter (37 CFR 1.125 (b))

### BACKGROUND OF THE INVENTION

1. Field of the Invention

The present invention relates generally to an input device for an optical positioning system. More particularly, it relates to a light-emitting stylus detection system with photosensors for use on various display devices including computer, notebook, tablet, television or whiteboard.

2. Description of the Related Art

The applications of the tablet devices provide intuitive user experience through finger or stylus interactions. However, most of such applications are limited to small display devices due to high production cost in making capacitive touch screen or embedded digitizer in the large display devices. The present invention relates to a peripheral input system that enables users to interact with their display devices through styluses, especially with large and non-touch display devices, such as desktop computer or television.

### SUMMARY OF THE INVENTION

1. In accordance with the present invention, the optical positioning apparatus comprises a light-emitting stylus, two scanning receivers, at least one processing unit and a communication unit. Both of the scanning receivers are located at the corners of the screen surface of display device, and both of the scanning receivers scan the screen surface of the display device to capture the specific wavelength of the light emitted by the pen tip of the stylus. The processing unit then converts the analog data from the scanning receivers into digital data to calculate the location of the stylus through triangulation.
2. An aspect of the present invention is an optical positioning method for display devices including computer, notebook, tablet, television, whiteboard, touch display or non-touch display This optical positioning method requires two scanning receivers to attach to the corners of the screen surface of the display device in order to scan the screen surface of the display device. The scanning receivers capture the specific wavelength of light emitted by the pen tip, convert the light signal into analog data, and then transfer to processing unit to calculate the location of pen tip through triangulation.

### BRIEF DESCRIPTION OF THE DRAWINGS

FIG. 1 illustrates a configuration of the optical positioning apparatus attached to the screen surface of the display device according to embodiments of the present invention.

FIG. 2 is a perspective view of a light-emitting stylus according to embodiments of the present invention.

FIG. 3 illustrates a simplified diagram of an example of circuitry of the optical positioning apparatus.

FIG. 4 illustrates another simplified diagram of an example of circuitry of the optical positioning apparatus.

FIG. 5 illustrates another simplified diagram of an example of circuitry of the optical positioning apparatus.

FIG. 6 illustrates various configurations of the scanning receivers attached to the corners of the screen surface of the display device according to embodiments of the present invention.

### DETAILED DESCRIPTION OF THE INVENTION

The present invention is to provide the apparatus and method for optical positioning, and is described in the following with the reference to the drawing art.

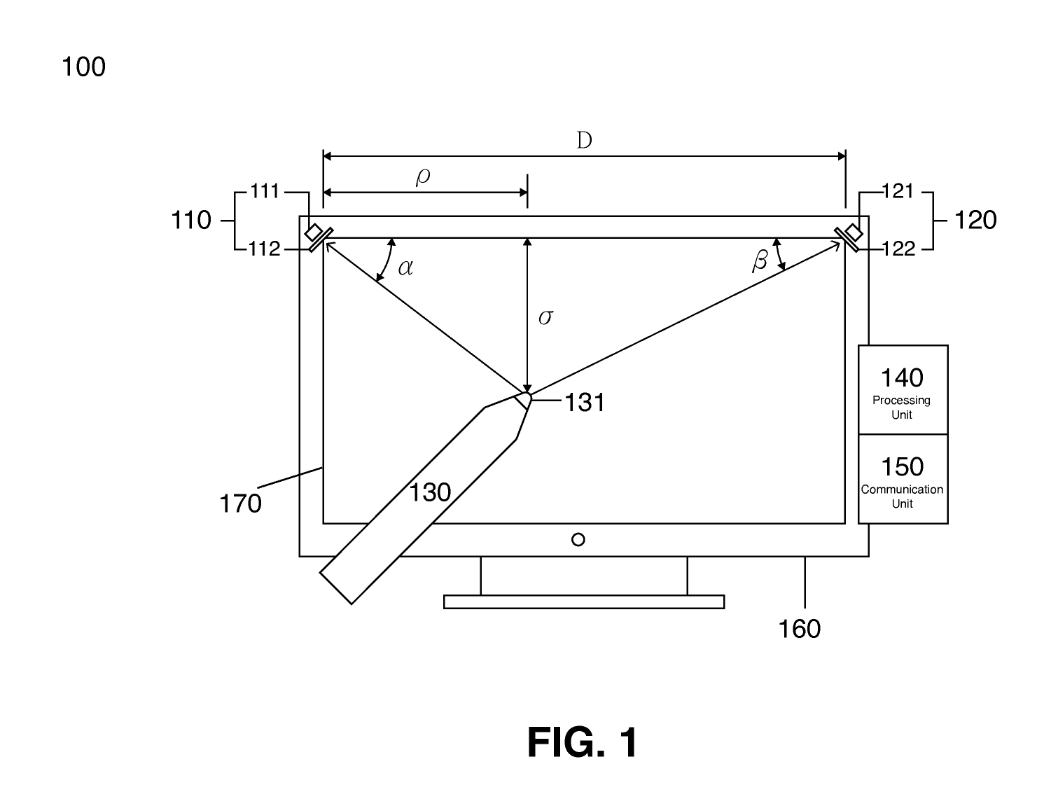

FIG. 1 illustrates a configuration of the optical positioning apparatus attached to the screen surface of the display device according to embodiments of the present invention. The optical positioning apparatus may be attached or embedded in the screen surface of various display devices including computer, television, whiteboard, notebook, mobile phone, tablet, mobile phone or tablet case, and any devices that are able to transfer data through communication with the optical positioning apparatus.

Referring to FIG. 1, the optical positioning apparatus 100 comprises two scanning receivers 110 and 120, a light-emitting stylus 130, a processing unit 140, and a communication unit 150.

In the present invention, the scanning receivers 110 and 120 are attached to the corners of the display device 160 so the scanning receivers 110 and 120 are able to scan the entire display area 170 in order to capture the specific wavelength of the light emitted by the pen tip 131 of the stylus 130 while the stylus 130 is activated. The left scanning receiver 110 comprises a photosensor 111 and a pass filter 112. Likewise, the right scanning receiver 120 comprises a photosensor 121 and a pass filter 122. The photosensor 111 and 121 are photodiodes, but can be substituted with other devices such as phototransistors.

The communication unit 150 functions as data communication between the optical positioning apparatus 100 and a display device, such as computer, television, tablet, smart phone, notebook, and any devices that are able to transfer data with the apparatus 100. The communication unit 150 may operate a short distance communication such as Bluetooth® or RF, and may also operate a wireless communication function such as Wi-Fi and Wireless Local Area Network (WLAN). The communication unit 150 may also be an USB (universal serial bus) or a HID (human interface device).

The present invention is the optical positioning method to triangulate the location of the pen tip 131. Referring to, FIG. 1, the scanning receivers 110 and 120 are located separately with a preset distance D. The scanning receiver 110 in relation to the pen tip 131 forms an angle α with reference to D. The scanning receiver 120 in relation to the pen tip 131 forms an angle β with reference to D. When the stylus 130 is in contact with the display area 170 and emits light to the pen tip 131, the processing unit 140 can identify the angle α through the analog data generated by photosensor 111. Similarly, when the stylus 130 is in contact with the display area 170 and emits light to the pen tip 131, the processing unit 140 can identify the angle β through the analog data generated by photosensor 121. The location of the pen tip 131 can be described as (ρ, σ) according to the Cartesian coordinate system. The distance of p is the distance between the left side of display area 170 and the stylus pen tip 131. The distance of σ is the distance between the topside of display area 170 and the stylus pen tip 131. The σ can be obtained with the following formula 1:

σ=D sin β/sin(180−α−β)

The ρ can be obtained with the following formula 2:

ρ=√((σ/sin α)²−σ²)

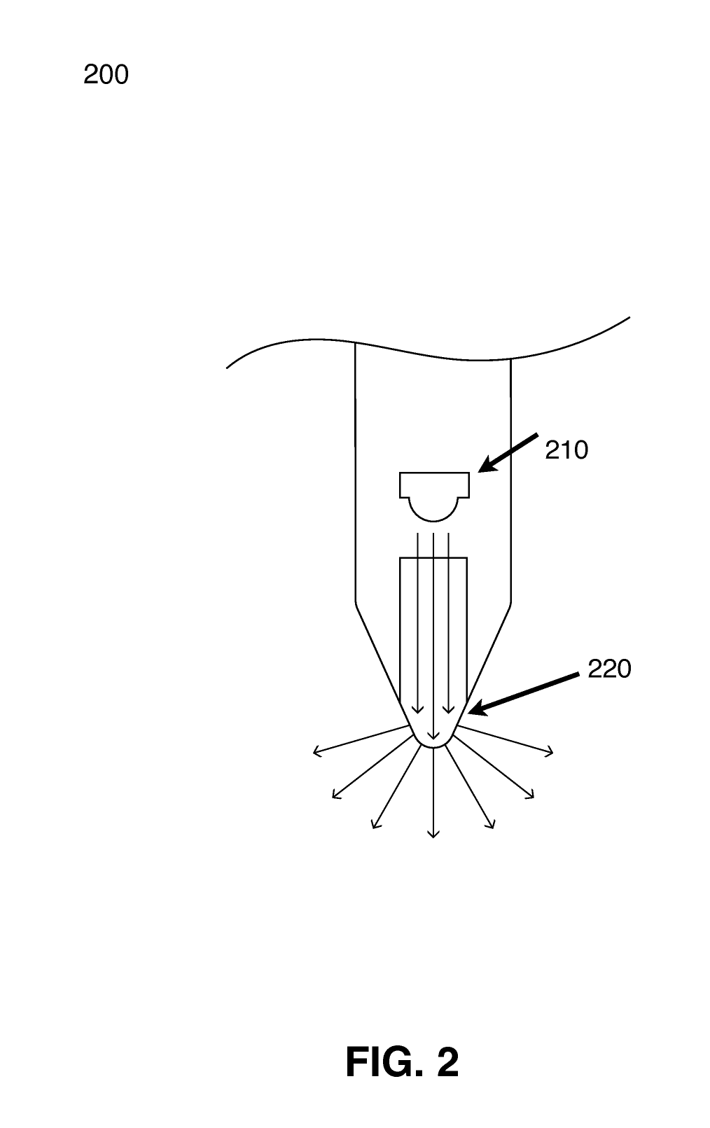

FIG. 2 is a perspective view of a light-emitting stylus 200 according to embodiments of the present invention. In the present invention, the light source 210 of the stylus 200 is LED (Light-Emitting Diode) such as 850 nm LED or 940 nm LED, and emits the light toward the pen tip 220. However, the light source 210 of the stylus 200 can also be substituted by laser diode. The wavelength of either LED or laser diode can be different from 850 nm or 940 nm in accordance with related modification of pass filter 112 and 122 in FIG. 1.

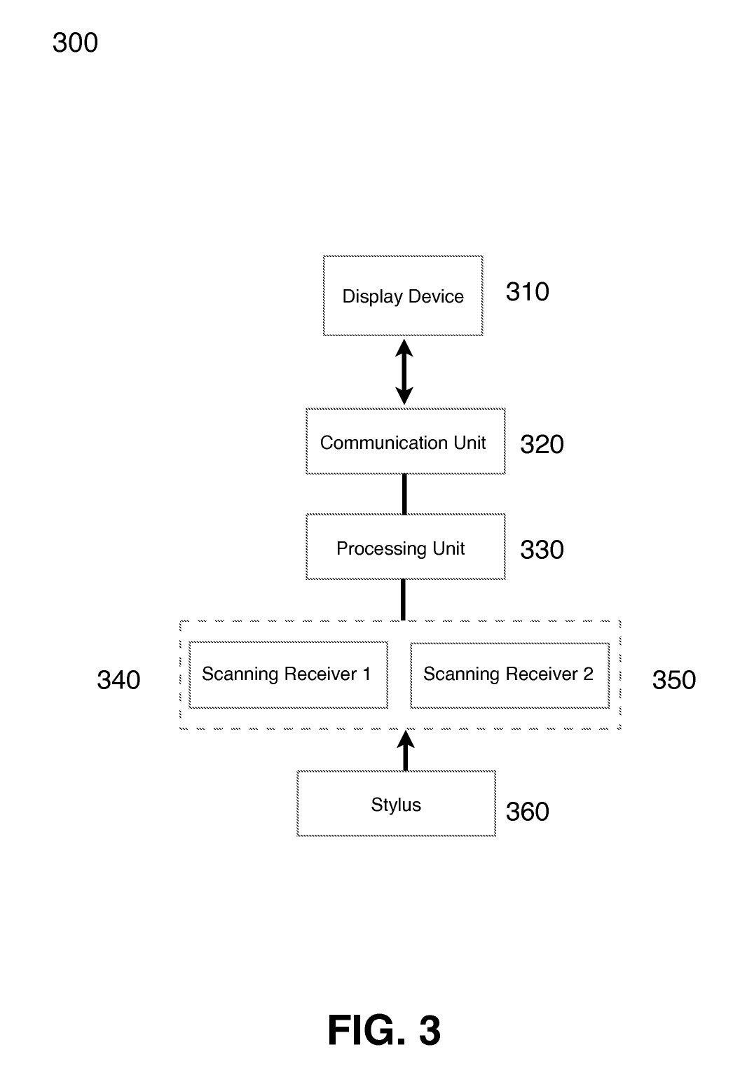

FIG. 3 illustrates a simplified diagram of an example of circuitry 300 of the optical positioning apparatus in accordance with the configuration of FIG. 1. The scanning receivers 340 and 350 capture the light emitted from the stylus 360, convert the light signal to analog signal, and then transfer the analog signal to the processing unit 330. The processing unit 330 calculates the location of the stylus 360 and communicates the location data to the display device 310 through the communication unit 320.

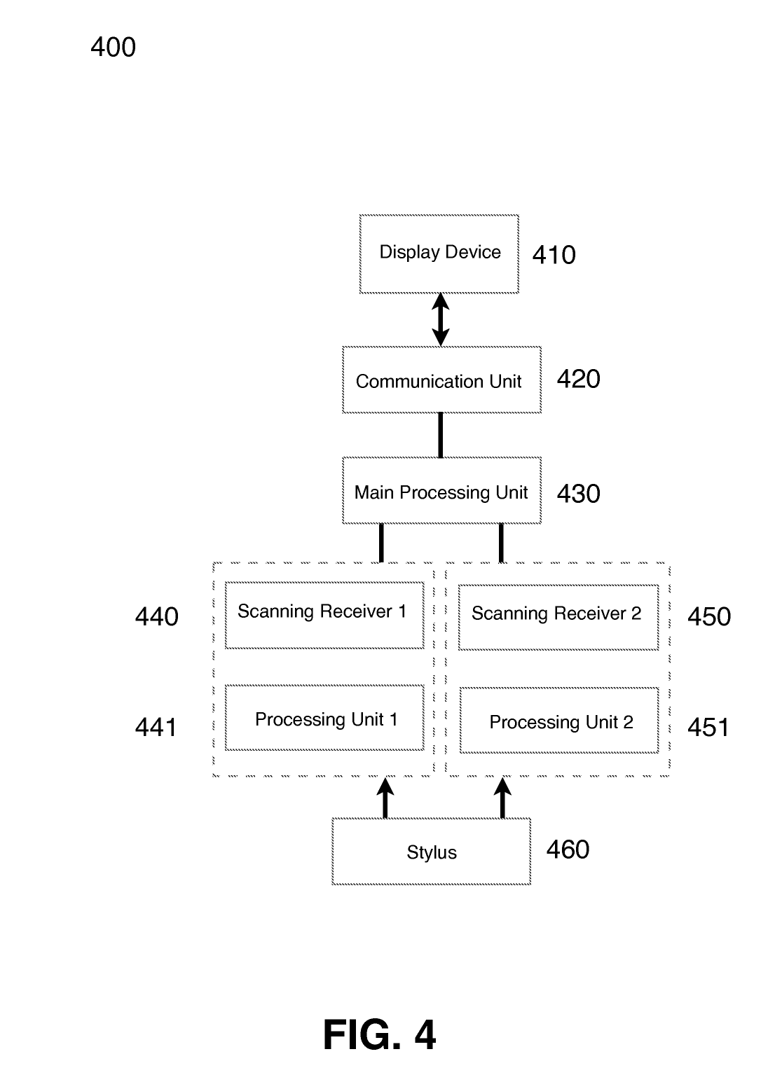

FIG. 4 illustrates another simplified diagram of an example of circuitry 400 of the optical positioning apparatus. The scanning receivers 440 and 450 may respectively include additional processing unit 441 and 451. The scanning receivers 440 and 450 capture the light emitted from the stylus 460, and individually convert the light signal to analog signal. Then the respective processing unit 441 and 451 individually convert the analog signal to digital data, and transfer the digital data to main processing unit 430. The main processing unit 430 calculates the location of the stylus 460 through triangulation, and transmits the location data to the display device 410 through the communication unit 420. The formulas to calculate the location of the stylus 460 are formula 1 and formula 2 mentioned previously in the description of FIG. 1.

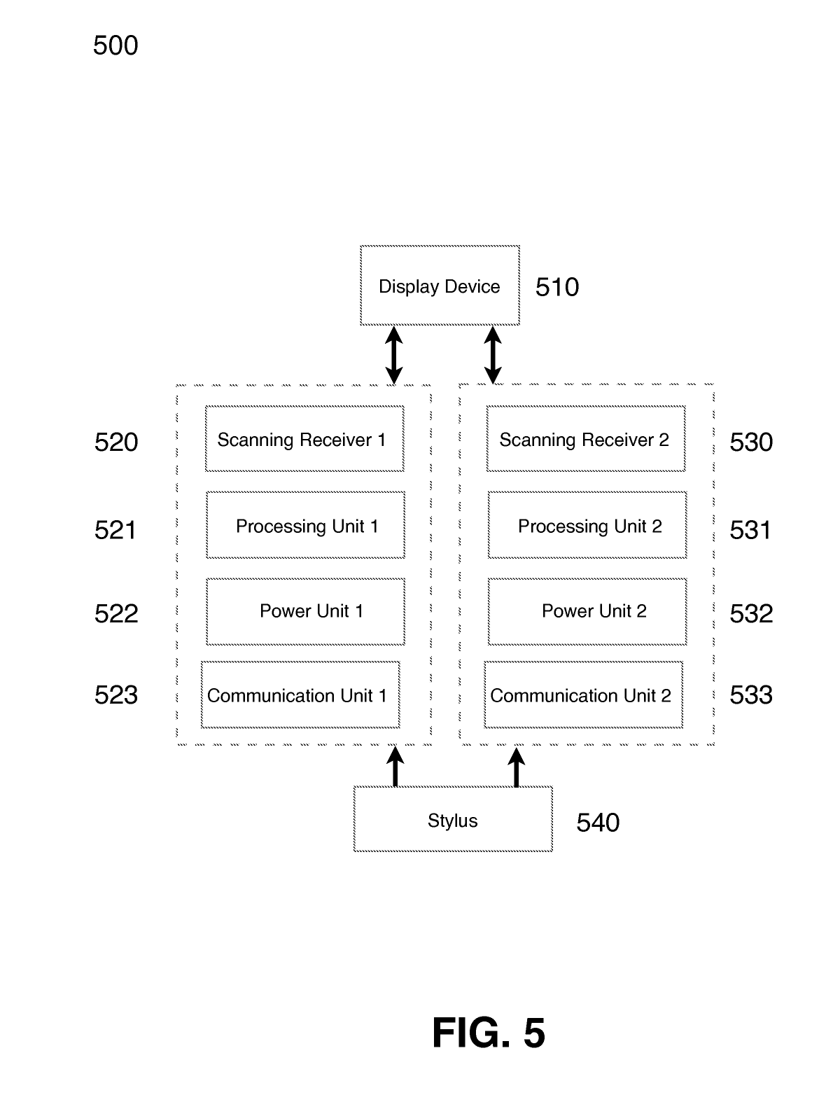

FIG. 5 illustrates another simplified diagram of an example of circuitry 500 of the optical positioning apparatus. The scanning receivers 520 and 530 may respectively include additional processing unit 521 and 531, power unit 522 and 532, and communication unit 523 and 533. The scanning receivers 520 and 530 capture the light emitted from the stylus 540, and individually convert the light signal to analog signal. Then the respective processing unit 521 and 531 individually convert the analog signal to digital data. The communication unit 523 transmits the digital data from the processing unit 521 to the processing unit of display device 510 wirelessly. Similarly, the communication unit 533 transmits the digital data from the processing unit 531 to the processing unit of display device 510 wirelessly. The processing unit of display device 510, which may be a central processing unit (CPU), calculates the location of the stylus 540 by gathering all the digital data received from the communication unit 523 and 533. The formulas to calculate the location of the stylus 540 are formula 1 and formula 2 mentioned previously in the description of FIG. 1.

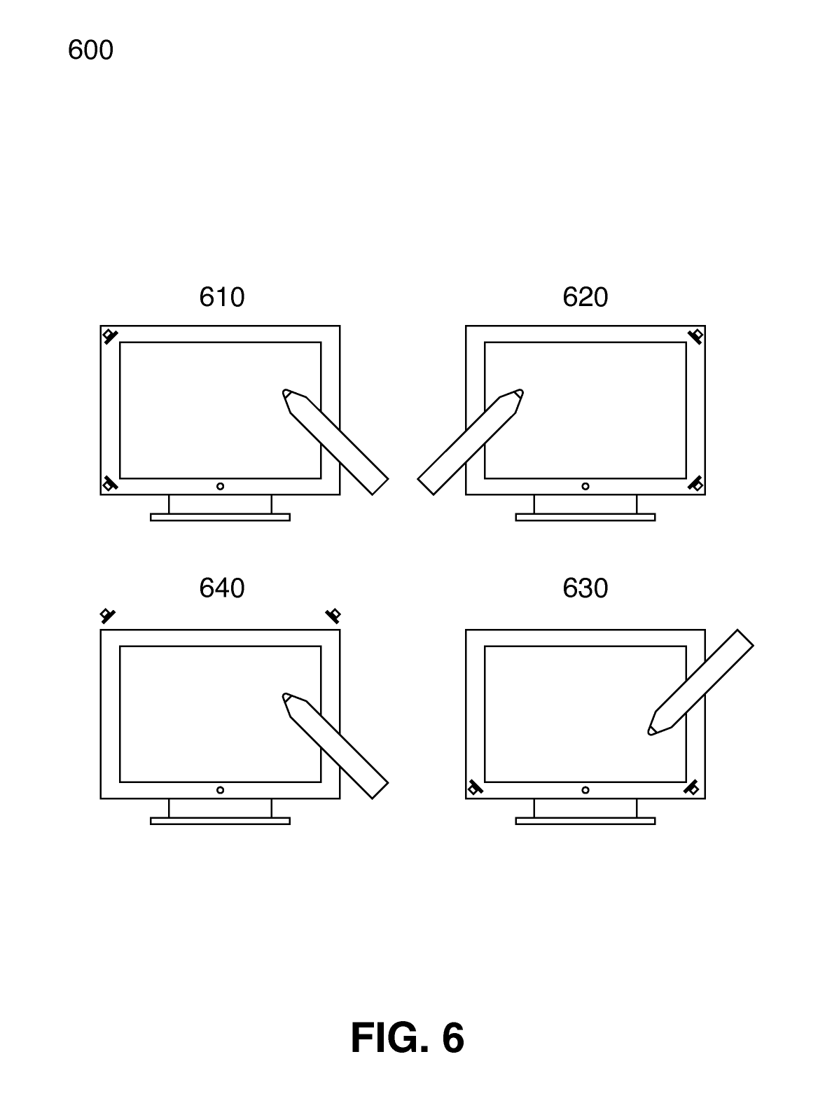

FIG. 6 illustrates various configurations 600 of the scanning receivers attached to the different corners of the screen surface of the display device according to embodiments of the present invention. The scanning receivers may be attached to the top left corner and bottom left corner as shown in 610. The scanning receivers may also be attached to the top right corner and bottom right corner as shown in 620. The scanning receivers may also be attached to the bottom left corner and bottom right corner as shown in 630. Furthermore, the scanning receivers may be located outside the screen surface of the display device with additional mechanical support as shown in 640.

It is to be fully recognized that the diagrams of FIG. 3, FIG. 4, FIG. 5 and FIG. 6 are illustrated for convenience of description. Furthermore, there are various modifications and variations fall within the scope of the present invention.

We claim:

1. An optical positioning apparatus comprises:
two scanning receivers that can be attached separately to the corners of the display device to capture the specific wavelength of light emitted by the pen tip of the stylus;
a stylus with a light source of LED (Light-Emitting Diode) or laser diode that is able to conduct the light to the pen tip;
at least one processing unit to calculate the location of the stylus through triangulation measurement; and
a communication unit that transmits the data from the processing unit to the display device, such as computer, television, notebook, whiteboard or tablet, with wired interface such as USB (universal serial bus) or a HID (human interface device), or with wireless interface such as Bluetooth® or RF.

2. The optical positioning apparatus of claim 1, wherein the communication unit may also operate a wireless communication function such as Wi-Fi and Wireless Local Area Network (WLAN).

3. The optical positioning apparatus of claim 1, wherein both the scanning receivers respectively comprise:
a photosensor to capture the light emitted by the pen tip of the stylus, and convert to analog signal; and
a pass filter to identify the light emitted by the pen tip of the stylus.

4. The optical positioning apparatus of claim 2, wherein the photosensor is a photodiode or a phototransistor.

5. A method for optical positioning comprising:
scanning a display area separately with two scanning receivers attached or embedded on the corners of the screen surface of a display device;
emitting light through the pen tip of the stylus with an embedded or internal light source;
capturing the specific wavelength of the light emitted by the pen tip of the stylus while the two scanning receivers are scanning the display area;
computing the location of the stylus through triangulation based on the preset distance of the two scanning receivers, and the varying angles between the two scanning receivers and the pen tip of the stylus; and
communicating the location data to a display device including computer, notebook, tablet, television, whiteboard, touch display or non-touch display.

6. The optical positioning method of claim 4, wherein the wavelength of the stylus light source is 850 nm or 940 nm. The wavelength can be applied differently from 850 nm or 940 nm in accordance with related modification of pass filter located in the scanning receiver.

7. The optical positioning method of claim 4, wherein the embedded or internal light source is light-emitted diode (LED), but can be substituted with other light sources such as laser diode.

8. The optical positioning method of claim 4, wherein the communicating the location data to a display device is through a wired interface such as USB (universal serial bus) or a HID (human interface device), or through a wireless interface such as Bluetooth®, RF and Wi-Fi.
